(19) United States
(12) Patent Application Publication
(10) Pub. No.: US 2005/0223663 A1
(43) Pub. Date: Oct. 13, 2005

(54) Door or window wing with an insulating-glass pane

(76) Inventor: Peter Schuler, Tiefenbronn (DE)

Correspondence Address: ORUM & ROTH, 53 W. JACKSON BLVD, CHICAGO, IL, 60604, US

(21) Appl. No.: 11/010,088

(22) Filed: Dec. 10, 2004

(30) Foreign Application Priority Data
Apr. 8, 2004 (DE) 10 2004 018 440.2

(51) Int. Cl. E06B 3/26; E06B 3/00

(52) U.S. Cl. 52/208

(57) ABSTRACT

A wing for a door or for a window comprising a wing frame and an insulating-glass pane mounted in the wing frame, wherein an interspace is enclosed by at least two glass panels held at a spacing one from the other, the interspace being sealed from penetration of humidity by a primary sealant provided in the marginal area of the glass panels between the latter; and wherein a firm bond is realized between the two glass panels by use of a secondary sealant; the wing frame having an inside, an outside, a mounting side and a glazing side in which a groove is formed for receiving the insulating-glass pane, the width of the groove being greater than the thickness of the insulating-glass pane, whereby a gap remains in the door or window wing on both sides of the insulating-glass pane, which gap needs to be closed. The invention provides that the secondary sealant, instead of being positioned between the glass panels is placed in the gaps where it produces a firm bond between the wing frame and the two outsides of the insolating-glass pane. The invention further describes a sealing device for such door or window

The present invention relates to a door wing or window wing.

There have been generally known door or window wings comprising a frame and an insulating-glass pane mounted in the frame wherein an interspace is enclosed by two glass panels held at a spacing one from the other, the interspace being sealed from penetration of humidity by a sealant provided in the marginal area of the glass panels between the latter—hereinafter referred to as a “primary sealant”, and wherein a firm bond is realized between the two glass panels by means of a secondary sealant consisting, for example, of a curable plastic material. The frame of the wing has an inside, an outside, a mounting side and a glazing side in which a groove is formed for receiving the insulating-glass pane, the width of the groove being greater than the thickness of the insulating-glass pane, whereby a gap remains in the door or window wing on both sides of the insulating-glass pane, which gap needs to be closed.

Insulating-lass panes mostly consist of two glass panels that are spaced apart by a metallic spacer frame and are bonded together using a primary sealant applied onto both flanks of the spacer frame. Spacer frames that are formed from steel or aluminium hollow profiles and that contain a drying agent intended to bind any humidity present in the inner space of the insulating-glass pane are commonly used. Commonly used as primary sealants are compounds on the basis of polyisobutylene (butyl caoutchouc), which prevent with sufficient reliability water vapour from diffusing into the inner space of the insulating-glass pane.

There have also been known insulating-glass panes the glass panels of which, instead of being held in spaced relationship by a metallic spacer frame, are spaced one from the other by a polyisobutylene-based thermoplastic rope with an included drying agent (EP 0 782 656 A1). Such a thermoplastic rope has the dual function of serving as s spacer and, on the other hand, of preventing water vapour from diffusing into the inner space. Compared with the use of metallic hollow sections in insulating-glass panes this has the advantage that it prevents creation of a cold bridge between the glass panels and that the separate fabrication of a spacer frame is rendered superfluous.

In both cases, the polyisobutylene-based sealant forms what is called a primary seal of the insulating-glass pane. However, due to its thermoplastic behaviour, the primary sealant is not in a position to provide a firm, sufficiently tension-proof and pressure-proof bond between the glass panels. Instead, such a bond is achieved by a secondary sealant, for which purpose a sufficiently curable plastic material is filled into a marginal groove of the insulating-glass pane, which groove is provided for this purpose on the outside of the metallic spacer frame or on the outside of a thermoplastic spacer, respectively, provided instead of a metallic spacer frame between the two glass panels. The secondary sealants commonly used are, especially, thiokols and polyurethanes. These materials bond firmly to the glass panels and also to the outside of the metallic spacer or of the polyisobutylene-based thermoplastic spacer, respectively, and, once hardened, guarantee the desired tension-proof and pressure-proof durable bond between the glass panels.

It has been known to mount such insulating-glass pane subsequently in a wing frame made from metal, wood or plastics.

Door or window wings are usually made by initially cutting the legs of the wing from profiled bar or from hollow profiled bar stock and thereafter joining the legs at the corners of the wing frame. In the case of wooden frames, this can be done by keying and/or gluing or by screwing. In the case of wing frames made from metal or plastics, modern processes mostly use extruded hollow profiled bars which are pre-cut and then welded at the corners, in the case of plastic hollow profiles by ultrasonic welding.

The wing frame receives the insulating-glass pane in a continuous groove deep enough to ensure that after installation in the wing frame only that surface of the spacer of the insulating-glass pane will remain visible that faces the inner space of the insulating-glass pane. In the present description that side of the wing frame which contains the groove for the insulating-glass pane is called the glazing side, whereas that side of the wing frame which, when installed in a wall of a building, faces the outside will be called herein the outside of the frame. The side which, when installed in the wall of a building, faces toward the inside will be called herein the inside of the frame, and the side that faces away from the glazing side will be called herein the mounting side due to the fact that it is prepared for installation of the window wing in a corresponding opening in a building.

In order to permit an insulating-glass pane to be mounted in a wing frame prepared for this purpose, the groove intended to receive the insulating-glass pane must still be open either on the outside or on the inside of the wing frame; usually, however, it will be open initially on the inside of the wing frame. Before mounting the insulating-glass pane in the wing frame, it has been known to provide a prefabricated, permanently elastic sealing gasket on the outer side wall of the groove, to apply the insulating-glass pane against that gasket and to then place an additional sealing gasket on the insulating-glass pane and to complete the wing frame by fitting a holding frame that forms the second side wall of the groove and serves to fix the insulating-glass pane in the wing frame with intermediate sealing gaskets provided on both sides. To this end, the holding frame is firmly connected with the wing frame and is then part of the wing frame.

As an alternative it has been known to mount the insulating-glass pane in the prepared wing frame, to complete the wing frame by fitting the wing frame and, subsequently, to push sealing gaskets into the groove on both sides of the insulating-glass pane or else to fill two gaps, that have been kept free between the insulating-glass pane and the two side walls of the groove of the wing frame, with a permanently elastic sealant, especially one based on a silicon caoutchouc.

Now, it is the object of the present invention to provide a window wing or a door wing with an insulating-glass pane the manufacture of which is easier and cheaper than herebefore.

It is a further object to provide an apparatus which can be used easier than herebefore to manufacture a window wing or a door wing with an insulating glass pane therein.

Accordingly, the present invention provides a door or window wing comprising a wing frame and an insulating-glass pane mounted in the wing frame, wherein an interspace is enclosed by at least two glass panels held at a spacing one from the other, the interspace being sealed from penetration of humidity by a primary sealant provided in the marginal area of the glass panels between the latter;
and wherein a firm bond is realized between the two glass panels by means of a secondary sealant;
the wing frame having an inside, an outside, a mounting side and a glazing side in which a groove is formed for receiving the insulating-glass pane, the width of the groove being greater than the thickness of the insulating-glass pane, whereby a gap remains in the door or window wing on both sides of the insulating-glass pane, which gap needs to be closed,
characterized in that the secondary sealant, instead of being positioned between the glass panels is placed in the gaps where it produces a firm bond between the wing frame and the two outsides of the insulating-glass pane.

Contrary to conventional window wings with conventional insulating-glass panes, a door or window wing according to the invention, instead of having the secondary sealant placed between the glass panels of the insulating-glass pane, has a secondary sealant placed in the gaps present on both sides of the insulating-glass pane between the latter and the lateral faces of the groove of the wing frame in which the insulating-glass pane is received. The secondary sealant in this position provides a firm bond between the wing frame and the outer faces of the glass panels. This means that the glass panels are not firmly bonded one to the other directly by a secondary sealant; instead, the secondary sealant creates an indirect bond only between the panels by bonding the outer faces of the two side walls of the groove, which are in contact with the glass panels, separately to the wing frame, in a permanently tension-proof and pressure-proof fashion. This provides essential advantages:
The process of applying a secondary sealant in the marginal groove of the insulating-glass pane is completely eliminated.
When the glass panels are bonded together, using a metallic or thermoplastic spacer, thereby forming a primary seal, no marginal groove needs to be provided for a secondary sealant. Accordingly, the invention can do without the marginal groove formed for this purpose in an insulating glass pane according to the prior art.
The area along the edge of the insulating-glass pane, which must be covered when the pane is mounted in the wing frame, can therefore be made smaller, compared with the prior art, by the size of the eliminated marginal groove for the secondary sealant.
Correspondingly, the groove in the wing frame in which the insulating-glass pane is to be received can be made shallower than in systems of the prior art.
Correspondingly, the sides of the wing frame can be made narrower than in systems of the prior art. This leads to a more attractive appearance.
The secondary sealant and the primary sealant can be optimized independently one from the other since the primary sealant is applied between the glass panels whereas the secondary sealant is located on the outside of the insulating-glass pane so that the two sealants are no longer in contact one with the other. Any incompatible interaction between the primary and the secondary sealants, for example migration of a softening agent from the primary into the secondary sealant and other incompatibilities between the materials that may reduce the service life of an insulating-glass pane, are no longer a critical issue in connection with door or window wings designed according to the invention.
The door or window wing can be assembled without any need for a separate holding frame for an insulating-glass pane. Instead, the loose legs of the wing frame can be arranged around the insulating-glass pane and can then be connected at their corners, especially by welding or gluing. Thereafter, only the gaps on both sides of the insulating-glass panes have to be sealed with the secondary sealant. This in addition requires less work and time than the process of mounting the elastomeric sealing gaskets of the prior art in the gaps.
The invention is particularly well suited for series production of window wings in standardized dimensions for which the invention permits an unequalled favourable price/performance ratio to be achieved.

The invention is suited for insulating-glass panes with metallic spacer frames, especially spacer frames made from hollow profiled or from U profiles.

Further, the invention is suited for insulating-glass panes formed with the aid of plastic hollow spacer profiles or U profiles containing a drying agent similar to metallic spacer frames. Such plastic spacer frames may consist of a synthetic resin containing pulverulent or fibrous fillers, especially a glass-fibre reinforced plastic material (DE 198 14 044 A1).

The invention is particularly advantageous when insulating-glass panes are used which, instead of being held by a metallic spacer frame, are maintained at a spacing by a plastics rope which at the same time forms the primary sealant and which may have thermoplastic properties.

The secondary sealant used may be a single-component or a two-component plastic material where the first component serves as a binder and the second component serves as a curing agent. Curing plastics, such as thiokols or polyurethanes, which have been used before as secondary sealants in insulating-glass panes, are likewise suited for purposes of the present invention. For purposes of the present invention it is no longer necessary to select and test such compounds as to their compatibility with the sealant used as primary seal, which is of course an advantage. In addition, the secondary sealant may also consist of reactive hot-melts which cure irreversibly.

In the case of conventional insulating-glass panes, the secondary sealant is not exposed to light. This is different with window wings according to the invention. Preferably, it is therefore provided that in order to prevent undesirably changes as a result of the effect of UV light, the curing plastic material contains a UV blocker. Soot is a suitable and effective UV blocker.

While the invention is suited for wing frames made from every kind of material, wing frames made from plastic materials are particularly preferred because they provide an especially good thermal insulation effect, especially in combination with insulating-glass panes comprising a thermoplastic spacer. Moreover, the greatest rationalization benefit can be achieved by the invention when wing frames made from plastic materials are used.

The invention is suited not only for insulating-glass panes consisting of two glass panels, but also for insulating-glass panes consisting of three glass panels. The fact that the middle glass panel of the insulating-glass pane is in this case not connected with the two outer glass panels by a tension-proof and pressure-proof secondary sealant has no disadvantageous effect whatsoever since the two outer glass panels are connected to the wing frame in tension-proof and pressure-proof fashion. What has been previously discussed in connection with insulating-glass panes consisting of two glass panels therefore likewise applies to insulating-glass panes formed from three parallel glass panels.

A device, which is particularly well suited for carrying out the invention comprises a horizontal conveyor on which the door wings and window wings can be placed in upright position;
supporting means which prevent the upright and moving door or window wings from overturning and which, preferably, consist of a number of parallel elongated supporting rollers or of parallel supporting rolls provided above the horizontal conveyor in an arrangement of their axes of rotation extending from the bottom to the top, such that their cylindrical lateral surfaces form a common tangential plane providing a supporting plane for the door or window wings;
a first nozzle guided for up and down movement on a guiding means provided in front of the supporting plane and extending in parallel to the supporting rollers or supporting rolls, respectively;
a second nozzle guided for up and down movement in parallel to the first nozzle, but located behind the supporting plane and especially behind the supporting rollers or supporting rolls, respectively, which nozzle protrudes from the rear through the supporting means, especially through the interspace between two neighbouring supporting rollers or supporting rolls, respectively;
the two nozzles being rotatable about an axis extending perpendicularly to the supporting plane;
and at least one feeding means for supplying the nozzles with a curing plastic material.

The supporting rollers permit, in an especially easy way, the door or window wings to be supported laterally and, simultaneously, the joints between the two outer faces of the insulating-glass pane and the lateral faces of the groove in the door or window wing to be sealed synchronously, for which purpose one of the nozzles used in this connection can protrude from the rear between the supporting rollers for sealing the rear gap. Instead of supporting rollers, against which door or window wings the top of which ends between the lower end and the upper end of the supporting rollers, can rest without any problem it is also possible to use supporting rolls which are shorter than supporting rollers. In this case, a plurality of supporting rolls can be arranged coaxially one above the other, and a plurality of lines of supporting rolls, arranged coaxially one above the other, can be arranged one beside the other, with their axes extending in parallel, to form a field of supporting rolls; in this case, the supporting rolls should conveniently by arranged one beside the other at offset levels so that the top of a door or a window wing will always rest against a supporting roll.

There is also the possibility to support the door or window wings by the use of a line of supporting rolls adjustable in height, or by the use of a driven endless supporting belt, likewise adjustable in height, although supporting the wings by a plurality of supporting rollers is the simplest solution.

The supporting arrangement for the door or window wings may be oriented vertically provided it prevents overturning of the door or window wings in some way or other. Preferably, the supporting arrangement is oriented at an acute angle relative to the vertical so that is will suffice to lean the door or window wings against the supporting arrangement.

The nozzles are movable up and down along their guide means and are rotatable about an axis extending perpendicularly to the supporting plane of the supporting means, i.e. for example to the tangential plane of the field of supporting rolls. This enables the two gaps to be sealed synchronously in a single pass, as known in connection with the sealing of the marginal groove of conventional insulating-glass panes with a secondary sealant (DE 28 16 437 C2).

Preferably, the nozzles used can be displaced in the direction of their rotary axes, and the rim of their discharge openings has a convex cross-section, in the direction of its circumference, whereby it is possible to give the surface of the curing plastic material a concave contour, which is advantageous for any water to run off and for window cleaning purposes.

Advantageous embodiments of the invention are illustrated in the attached drawings, in part diagrammatically, and will be described hereafter.

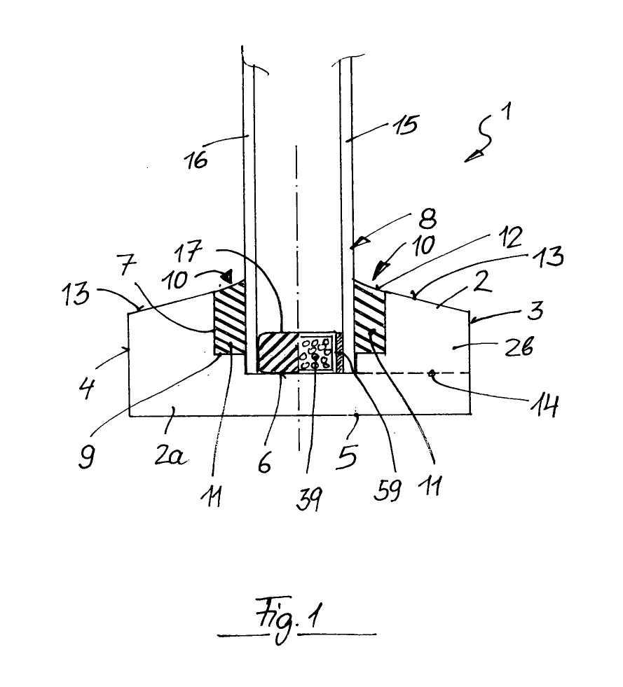

FIG. 1 shows, in diagrammatic representation, a cross-section of a detail of a door or window wing according to the invention;

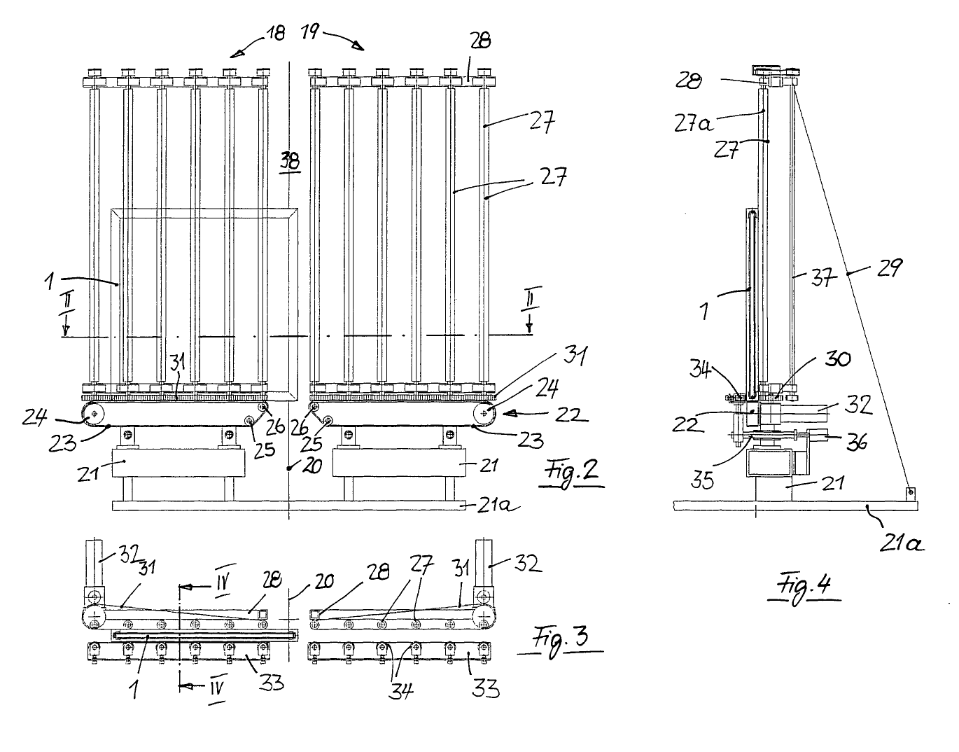

FIG. 2 shows a front view of a device in which door or window wings can be placed upright, can be conveyed in horizontal direction and can be supported for sealing of the two gaps;

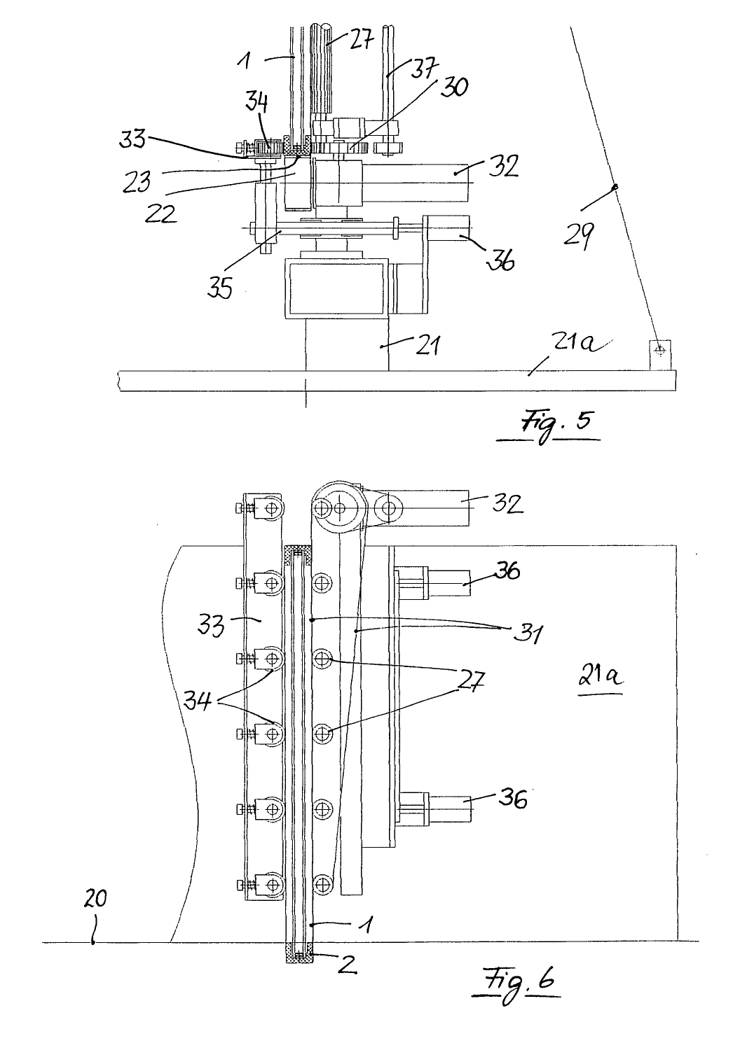

FIG. 3 shows a horizontal section of the device illustrated in FIG. 2, taken along line II-II;

FIG. 4 shows a section along line IV/IV in FIG. 3;

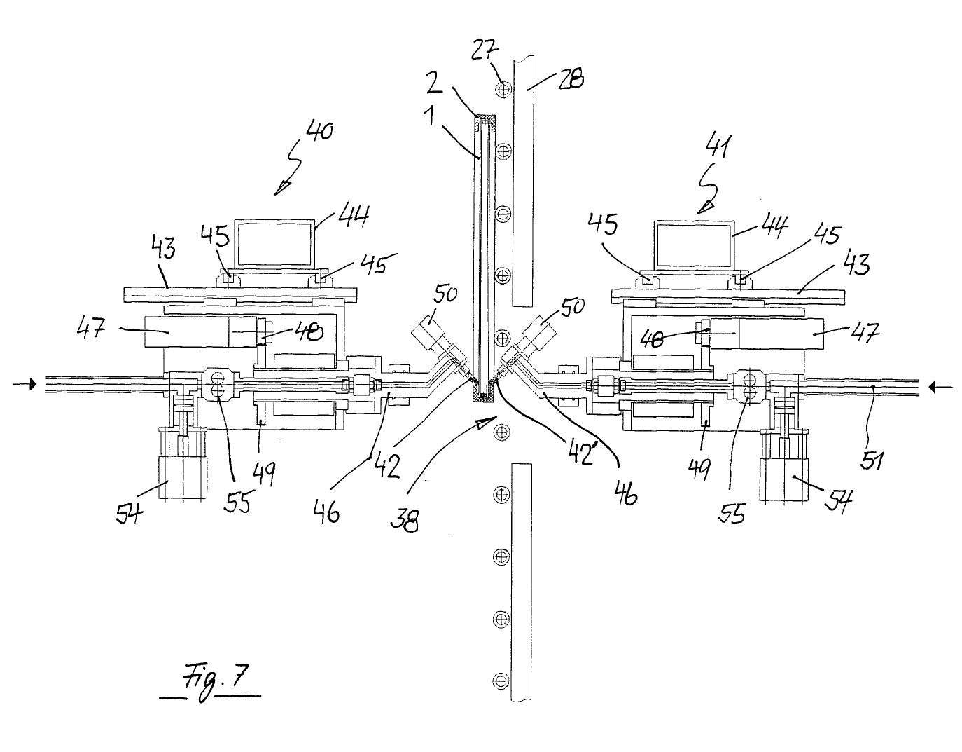

FIG. 5 shows an enlarged section of a detail of FIG. 4;

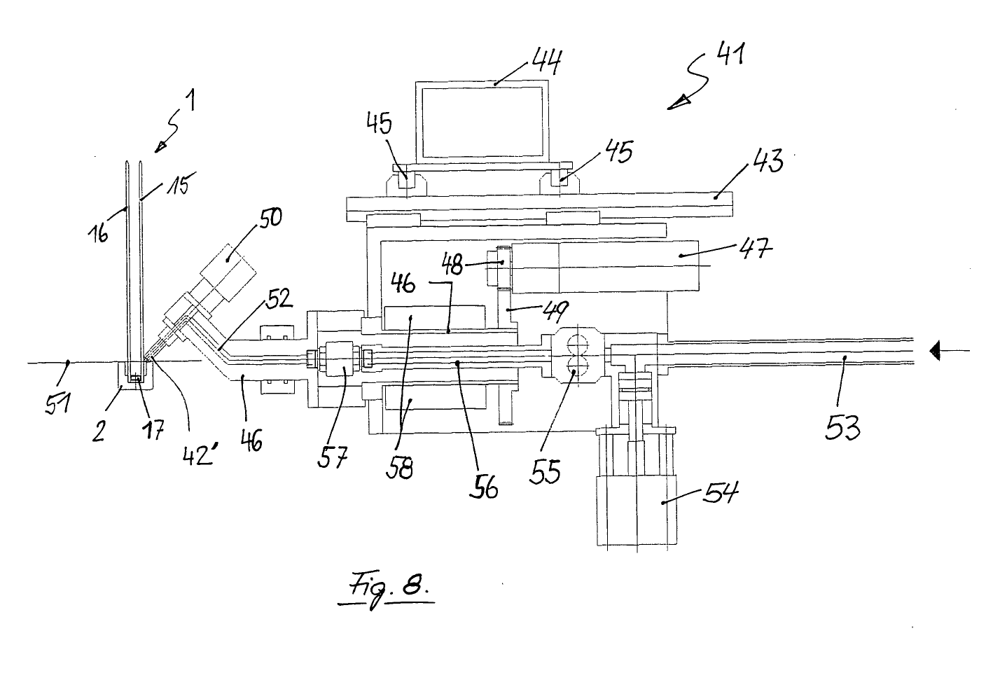

FIG. 6 shows an enlarged section of a detail of FIG. 3;

FIG. 7 shows a horizontal section illustrating the relative arrangement of two sealing units of the device illustrated in FIGS. 2 to 6;

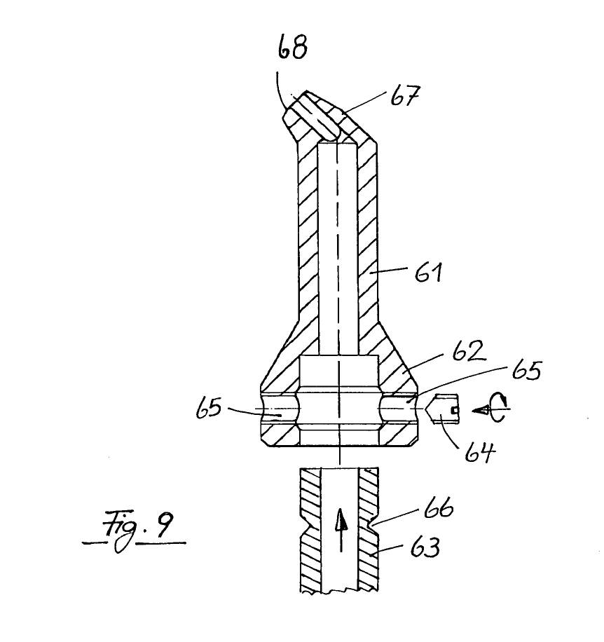

FIG. 8 shows a section of FIG. 7, in enlarged scale;

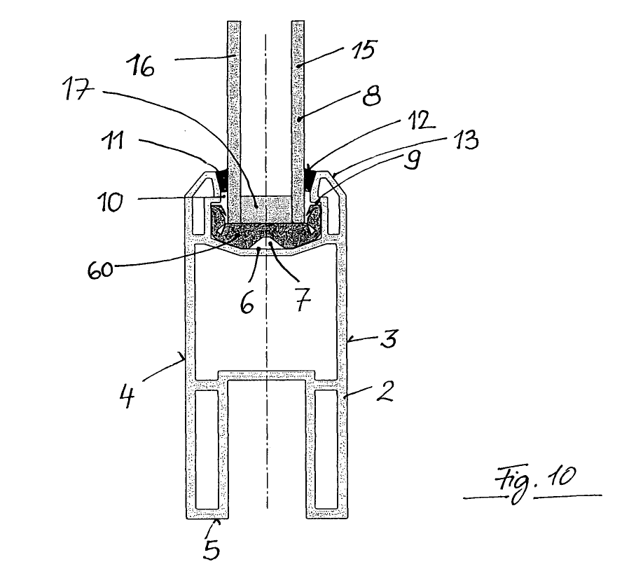

FIG. 9 shows a detail illustrating the nozzle that may be used in the sealing device described; and

FIG. 10 shows a realistic representation of a portion of a door or window wing modified relative the one shown in FIG. 1.

In the drawings, identical or corresponding parts are identified by the same reference numerals.

The door or window wing 1 illustrated in FIG. 1 comprises a wing frame 2 with an inside 3, an outside 4, a mounting side 5 and a glazing side 6, on which is formed a groove 7 with stepped cross-section whose width, measured in the deepest portion of the groove 7, is closely adapted to the thickness of an insulating-glass pane 8 to be mounted. The groove 7 widens at a step 9, whereby a gap 10 is provided on both sides of the insulating-glass pane 8, between the side walls of the groove 7 and the mounted insulating-glass pane 8, which gap is sealed with a secondary sealant 11. The surface 12 of the latter preferably has a concave shape and transitions preferably continuously into a surface 13 of the wing frame 2 that drops in a direction away from the insulating-glass pane 8.

The wing frame 2 is formed by four single-piece sections of a plastic profile having the cross-section illustrated in FIG. 1, which are fitted on the edges of the insulating-glass pane 8 and are glued or welded together at the corners of the insulating-glass pane. However, there is also the possibility to make the wing frame from sections of two different plastic profiles, by combining a first, essentials L-shaped profile section 2a, on which the mounting side 5 is formed, and a second L-shaped profile section 2b, on which the inside 3 is formed, to form a composite wing frame 2, having the profile as shown in FIG. 1 and being composed as illustrated by the broken separating line 14 in FIG. 1. To this end, one initially forms from the first profile sections 2a a frame with one open side in which the insulating-glass pane 8 is mounted. Using the second profile sections 2b one then forms a holding frame, which is fitted on the insulating-glass pane 8 so mounted, thereby completing the wing frame 2 with the cross-sectional configuration illustrated in FIG. 1.

The insulating-glass pane 8 consists of two glass panels 15 and 16, which are bonded together via a spacer 17 that contains a drying agent 39. The spacer used may be a thermoplastic spacer, as illustrated in the left half of FIG. 1, or a spacer made of a hollow profile of metal or plastics, as illustrated in the right half of FIG. 1, which is bonded to the glass panels 15 and 16 by means of a primary sealant 59.

The embodiment of the door or window wing illustrated in FIG. 10 differs from that shown in FIG. 1 in that the wing frame 2 is composed of four single-piece multi-chamber hollow profile sections which can be produced by extrusion. Although the groove 7, which accommodates the insulating-glass pane, likewise comprises a step 9 where the clear width of the groove 7 changes, the groove 7, contrary to the first embodiment, now has a greater clear width in its lower section than in its higher section. Fitted captively in the lower section of the groove 7, with the greater clear width, is a seal 60 in the form of an extruded profile which embraces the edge of the insulating-glass pane 8 in the form of a U. The higher section of the groove 7, with the smaller clear width, tapers outwardly toward the top, whereby a correspondingly widening wedge-shaped gap 10 is formed between the insulating-glass pane 8 and the side walls of the groove 7, which gap 10 is closed by a curable secondary sealant 11 placed at a spacing from the seal 60. The spacer 17 of the insulating-glass pane 8 is a rope of thermoplastic primary sealant with a drying agent contained therein. The primary sealant may be one based on a polyisobutylene.

The device illustrated in FIGS. 2 to 6 is subdivided into two sections 18 and 19 provided essentially in mirror-symmetrical arrangement relative to a vertical centre plane 20. Each section 18, 19 comprises, on a mount 21, a horizontal conveyor 22 consisting essentially of an endless conveyor belt 23, tensioned about a driven pulley, and two free-wheeling pulleys 25 and 26. The upper strand of the conveyor belt 23 is supported by supporting means to prevent sagging. The supporting means is not shown. It may for example consist of a horizontal rail or of a line of rolls.

Laterally above the conveyor belt 23, there is provided a field of parallel supporting rollers 27, all having the same diameter, whose axes 27a extend in a common plane that is inclined to the rear by a few degrees, for example by 60. The supporting rollers 27 are carried in a frame 28 which is braced on the mount 21 or a base 21a of the mount 21 by means of struts 29. Below each of the supporting rollers 27, there is provided a pulley 30 connected coaxially with the supporting roller 27 so as to rotate therewith. The belt 21, for example a toothed belt, whose front extends in the same plane as the front of the supporting roller 27, or slightly before that plane, is tensioned about the pulleys 30. The belt 31 is driven by an electric motor 32 which can also synchronously drive the supporting rollers 27. The driving action for the supporting rollers 27 is synchronized with the driving action for the conveyor belt 23.

In order to achieve good synchronization of the supporting rollers 27, the latter are driven at their two ends, for which purpose a shaft 37, extending in parallel to the rollers and coupling the upper ends and the lower ends of the supporting rollers 27 for driving purposes, is arranged behind the supporting rollers 27.

For the secondary sealing process, the door or window wing 1 is placed on the conveyor belt 23 and leaned against the supporting rollers 27. In order to prevent slippage between the door or window wing 1 and the belt 31 during transport of the window wing 1, there is provided a horizontal strip 33 which carries the free-wheeling rolls 34 whose axes of rotation extend in parallel to the axes of rotation 27a of the supporting rollers 27. The free-wheeling rolls 34 face the belt 31 and can be approached to the latter by means of a displacing mechanism 35 which can be operated by a hydraulic or pneumatic cylinder, whereby the door or window wing 1 can be pressed against the belt 31 so as to provide frictional connection between the door or window wing 1 and the belt 31.

As illustrated in FIG. 7, the device shown in FIGS. 2 to 6 cooperates with two sealing apparatuses 40 and 41, each of which comprises a nozzle 42, 42′ engaged in the gap 38 between the two sections 18 and 19 of the device. The sealing apparatus 40 is positioned behind the supporting rollers 27, the sealing apparatus 41 is positioned before the supporting rollers 27. The two sealing apparatuses 40 and 41 have, generally, the same structure. They comprise a carriage 43 that can be moved up and down along a column 44. To this end, guides 45 are formed on the column 44, which guides extend in parallel to the supporting rollers 27 so that the carriage 43 can be moved up and down in parallel to the supporting rollers 27. The carriage 43 carries a hollow shaft 46 that can be driven by an electric motor 47 via matching gears 48 and 49. The nozzle 42, 42′ and a shut-off valve 50 for the nozzle 42, 42′ are arranged on one end of the shaft 46. The end of the shaft 46, where the nozzle 42, 42′ is mounted, is bent off relative to the axis of rotation 51 of the shaft 46. In the shaft 46, there extends a channel 52 through which a curable plastic material can be supplied for sealing the gaps 10 of the window wing 1. The shaft 46 is seated rotatably in a bearing 58 mounted on the carriage 43.

The secondary sealant is pumped into a supply line 53, using a barrel pump not shown in the drawing, and enters an intermediate storage 54 in the form of a piston-and-cylinder unit mounted on the carriage 43. The intermediate storage 54 serves as buffer and enables a gear pump 55 to be fed with the secondary sealant at a constant initial pressure. The gear pump 55 delivers the secondary sealant through a conduit 56 into the hollow shaft 46, for which purpose the conduit 56 and the hollow shaft 46 are connected by a twist coupling 57. The gear pump 55 and the conduit 56 are likewise mounted on the carriage 43. The conduit 56 conveniently extends into the hollow shaft 46, which latter is driven by the motor 47. Using the gear pump 55, the secondary sealant can be supplied to the nozzle 42, 42′ at an adjustable rate.

Sealing the gaps 10 of a window wing 1 can be effected as follows: The door or window wing 1 is transported by means of the horizontal conveyor 22 and is stopped when its front section engages in the gap 38 between the two sections 18 and 19 of the device. The two nozzles 42, 42′ are then advanced toward the door or window wing 1 so that they are precisely directed into the two gaps 10 at the forward lower inner corner of the window wing 1, as illustrated in FIGS. 7 and 8. With the door or window wing 1 in stationary condition, the nozzles 42, 42′ are then first moved in upward direction until they reach the inner forward upper corners, and during that upward movement the secondary sealant is extruded into the gaps 10. The nozzles 42, 42′ are then stopped at the forward upper corner of the window wing 1 and turned by 90°. During that motion, the gaps 10 facing the nozzle openings, lying on the axis of rotation 51, retain their position in the corner and after completion of their rotary movement they are directed toward the top so that they are now in a position to seal the upper portion of the gaps 10. This is effected by retaining the nozzles 42, 42′ in their position while the door or window wing 1 is continuously advanced by means of the horizontal conveyor 22 until the rear upper inner corner of the window wing 1 reaches the nozzles 42, 42′. The horizontal conveyor is then stopped, and the nozzles are once more rotated by 90° so that thereafter they are directed toward the portions of the gaps 10 at the rear side of the window wing 1. With the door or window wing 1 in stationary condition, the nozzles 42, 42′ are then moved in downward direction so as to seal the rear vertical portion of the gaps 10. When the nozzles 42, 42′ reach the rear lower inner corner of the window wing 1, they are stopped and rotated once more by 90° so that they are now directed toward the lower portions of the gaps 10. The door or window wing 1 is then moved in opposite direction, during which motion the lower portion of the gaps 10 is sealed. The sealing process is completed when the inner forward lower corner of the window wing 1 reaches the nozzles 42, 42′. The two nozzles 42, 42′ are withdrawn a certain distance from the door or window wing 1 so as to release the door or window wing 1 which thereupon is transported off. Thereafter, the next door or window wing can be moved to the sealing position.

FIG. 9 shows an enlarged longitudinal section through a detail of one embodiment of a nozzle 42. The nozzle 42 has a tubular main body 61 with a coupling 62 formed on its read end; the end of conduit 43 can be moved right down in the coupling and can be fixed therein by two grub screws 64 which are screwed into transverse bores 65 and whose tips engage in matching recesses 66 in the conduit 63. The secondary sealant is supplied through the conduit 63. The nozzle 42 has an orifice 67 which is bent off at an angle of approximately 450 relative to the main body 61. The front 68 of the orifice 67 of the nozzle has a convex shape so that the surface of the secondary sealant 11 filled into the gap 10 of a door or window wing will exhibit a correspondingly concave contour—see FIG. 1 and FIG. 10.

Reference numerals:
1. Door or window wing
2. Wing frame
2a. Section of first L-shaped profile
2b. Section of second L-shaped profile
3. Inside
4. Outside
5. Mounting side
6. Glazing side
7. Groove
8. Insulating-glass pane
9. Step
10. Gap
11. Secondary sealant (curing plastic material)
12. Surface of 11
13. Inclined surface of 2
14. Separating line
15. Glass panel
16. Glass panel
17. Spacer
18. Portion
19. Portion
20. Centre plane
21. Mount
21a. Base
22. Horizontal conveyor
23. Conveyor belt
24. Driven pulley
25. Guide pulleys
26. Guide pulleys
27. Supporting rollers
27a. Axis
28. Frame
29. Struts
30. Pulleys
31. Belt
32. Electric motor
33. Strip
34. Rolls
35. Displacing mechanism
36. Pressure-fluid cylinder
37. Shaft
38. Gap
39. Drying agent
40. Sealing apparatus
41. Sealing apparatus
42, 42′ Nozzle
43. Carriage
44. Column
45. Guides
46. Hollow shaft
47. Electric motor
48. Gears
49. Gears
50. Shut-off valve
51. Axis of rotation
52. Channel
53. Supply line
54. Intermediate storage
55. Gear pump
56. Conduit
57. Twist coupling
58. Bearing
59. Primary sealant
60. Seal
61. Main body
62. Coupling
63. Conduit
64. Grub screw
65. Transverse bore
66. Recess
67. Orifice
68. Front of 67

1. Wing for a door or for a window comprising a wing frame and an insulating-glass pane mounted in the wing frame, wherein an interspace is enclosed by at least two glass panels held at a spacing one from the other, the interspace being sealed from penetration of humidity by a primary sealant provided in the marginal area of the glass panels between the latter;
and wherein a firm bond is realized between the two glass panels by means use of a secondary sealant;
the wing frame having an inside, an outside, a mounting side and a glazing side in which a groove is formed for receiving the insulating-glass pane, the width of the groove being greater than the thickness of the insulating-glass pane, whereby a gap remains in the door or window wing on both sides of the insulating-glass pane, which gap needs to be closed,
wherein the secondary sealant, instead of being positioned between the glass panels is placed in the gaps where it produces a firm bond between the wing frame and the two outsides of the insolating-glass pane.

2. The wing as defined in claim 1, further comprising a metallic spacer frame is positioned between the glass panels which is firmly bonded to the two glass panels by means use of the primary sealant.

3. The wing as defined in claim 1, further comprising a spacer frame made from a plastic material is positioned between the glass panels which is bonded to the two glass panels by use of the primary sealant.

4. The wing as defined in claim 3, wherein the spacer frame comprises a plastic material containing a pulverulent or fibrous filler.

5. The wing as defined in claim 1, wherein the glass panels are bonded together by use of a strand of the primary sealant which is formed to a spacer (17).

6. The wing as defined in claim 1, wherein the primary sealant is a thermoplastic compound.

7. The wing as defined in claim 1, wherein the primary sealant is an elastomeric compound.

8. The wing as defined in claim 6, wherein the primary compound is a polyisobutylene-based compound.

9. The wing as defined in claim 1, wherein the secondary sealant (11) is a curable plastic material.

10. The wing as defined in claim 9, wherein the curable plastic material comprises a first component serving as a binder and a second component serving as a curing agent.

11. The wing as defined in claim 9, wherein the secondary sealant is a Thiokol or a polyurethane.

12. The wing as defined in claim 9, wherein the secondary sealant is a reactive hot-melt.

13. The wing as defined in claim 1, wherein the secondary sealant contains a UV blocker such as soot.

14. The wing as defined in claim 1, wherein the wing frame is formed from hollow sections.

15. The wing as defined in claim 14, wherein the wing frame comprises four single-piece hollow-profile legs which are firmly connected at the four corners of the wing frame.

16. The wing as defined in claim 1, wherein the wing frame comprises a plastic material.

17. The wing as defined in claim 1, wherein the insulating-glass pane is formed from two or three parallel glass panels.

18. A device for sealing the two gaps between an insulating-glass pane and the lateral surfaces of a groove in a wing frame in which the insulating-glass pane is fitted, especially in a door or window wing, as defined in claim 1, further comprising a horizontal conveyor on which the door or window wings can be placed in upright position;
a supporting element which defines a supporting plane for the door or window wing above the horizontal conveyor and which is arranged and configured in such a way as to prevent the door or window wings placed on the horizontal conveyor from overturning;
a first nozzle guided for up and down movement on a guiding element, provided in parallel to the supporting plane, in front of the supporting plane;
and a second nozzle located parallel to the first nozzle but behind the supporting plane and which protrudes from the rear through the supporting element, the two nozzles being rotatable about an axis;
and at least one feeding element for supplying the nozzles with a sealant.

19. The device as defined in claim 18, wherein the front of the nozzles has a convex contour around its orifice.

20. The device as defined in claim 18, wherein the supporting plane includes an acute angle with the vertical.

21. The device as defined in claim 18, wherein the orifice of the nozzles is oriented relative to the axis about which it can be rotated so that the cross-sectional surface of the orifice includes with the axis an angle of between 20° and 80°.

22. The device as defined in claim 21, wherein the average angle is approximately 45°.

23. The device as defined in claim 18, wherein the axis about which the nozzle can be rotated extends through the orifice of the nozzle.

24. The device as defined in claim 18, wherein the nozzle can be displaced in the direction of the axis about which it can be rotated.

25. The device as defined in claim 18, wherein the supporting element comprises a number of parallel supporting rollers or supporting rolls having axes of rotation which are arranged above the horizontal conveyor from the bottom to the top in such a way that their cylindrical lateral surfaces form a common tangential plane providing the supporting plane, the first nozzle being guided for up and down movement on the guiding element provided in front of the supporting plane and extending in parallel to the supporting rollers or rolls, while the second nozzle is located behind the supporting rollers or supporting rolls.

26. The device as defined in claim 25, wherein the second nozzle protrudes from the rear through the space between two neighboring supporting rollers.

27. The device as defined in claim 19, wherein the front of the nozzles has a convex contour around its orifice.

28. The wing as defined in claim 15 wherein the legs are firmly connected at the four corners of the wing frame by welding or gluing.
